(19) United States
(12) Patent Application Publication
(10) Pub. No.: US 2026/0367427 A1
(43) Pub. Date: Nov. 19, 2026

(54) MICRO-RING MODULATOR AND METHOD FOR OPERATING THE SAME

(71) Applicant: Taiwan Semiconductor Manufacturing Company, Ltd., Hsinchu (TW)

(72) Inventors: Chia-Wei CHIANG, Hsinchu (TW); Lian Wee LUO, Hsinchu (TW); Chi-Yuan SHIH, Zhubei (TW); Chun-Pei WU, Mingjian (TW); Tse-En CHANG, Hsinchu (TW); Shih-Fen HUANG, Zhubei (TW)

(73) Assignee: Taiwan Semiconductor Manufacturing Company, Ltd., Hsinchu (TW)

(21) Appl. No.: 19/753,983

(22) Filed: Jul. 24, 2026

Related U.S. Application Data
(63) Continuation of application No. 18/810,099, filed on Aug. 20, 2024.

(51) Int. Cl. G02F 1/015

(52) U.S. Cl. CPC G02F 1/0151; G02F 2203/15

(57) ABSTRACT

A method for operating an optical device is provided. The optical device includes a first waveguide, a second waveguide, and a resonant waveguide. The method includes coupling a light signal into the first waveguide through an input port of the first waveguide, and coupling the resonant waveguide to the first waveguide. The resonant waveguide includes a P/N junction configured to modulate a resonance frequency of the resonant waveguide until the light signal is resonant in the resonant waveguide. The method further includes coupling the second waveguide to the resonant waveguide to output the light signal to a drop port of the second waveguide.

### RELATED APPLICATION

This application is a continuation of U.S. application Ser. No. 18/810,099 filed Aug. 20, 2024, the entire content of which is incorporated herein by reference.

### BACKGROUND

Micro-ring modulators (MRM) are very promising for providing a high data transmission rate, an ultra-low power consumption, and a small footprint (or size) for high-speed data communication systems. However, the laser energy may be trapped in the micro-ring modulator and the high laser power will induce non-linear effects, such as self-heating effects and two-photon absorption effects, in the micro-ring modulator. The non-linear effects may significantly degrade the modulation speed, the quality factor, and the optical modulation amplitude (OMA) of the micro-ring modulator.

As such, advances in the field of forming a micro-ring modulator are necessary to reduce the non-linear effects in the micro-ring modulator and maintain the quality factor and the modulation bandwidth. And further improvements are needed in order to meet the desired design criteria such that high-speed data communication for optical devices may be maintained.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 illustrates a process flow of operating an optical device, according to embodiments of the disclosure.

FIG. 2 illustrates a diagram of a micro-ring modulator, according to embodiments of the present disclosure.

FIG. 3 illustrates a diagram of a bias voltage signal for the P/N junction, according to embodiments of the present disclosure.

FIG. 4 illustrates a diagram of a micro-ring modulator, according to embodiments of the present disclosure.

FIG. 5 illustrates a diagram of a micro-ring modulator, according to embodiments of the present disclosure.

FIG. 6 illustrates a diagram of a micro-ring modulator, according to embodiments of the present disclosure.

FIG. 7A is a diagram showing an external configuration of a computer system for operating a micro-ring modulator according to embodiments of the present disclosure.

FIG. 7B is a diagram showing an internal configuration of a computer system for operating a micro-ring modulator according to embodiments of the present disclosure.

### DETAILED DESCRIPTION

It is to be understood that the following disclosure provides many different embodiments, or examples, for implementing different features of the disclosure. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. In addition, the term “made of” may mean either “comprising” or “consisting of.”

All pass micro-ring modulators are used for signal modulation for optical signals, and high input laser power is applied to meet the optical link budget requirements. However, high laser power will induce non-linear effects within the micro-ring modulators. For example, self-heating effects and two-photon absorption effects will reduce the communication bandwidth of the micro-ring modulators. In some examples, to reduce the non-linear effects, passive add-drop micro-ring modulators are used. However, due to the extra coupling between the micro-ring modulator and the add-drop waveguides, the quality factor and the optical modulation amplitude (OMA) are degraded. Embodiments of this disclosure provide an improved micro-ring modulation structure and methods of operating the same, thereby reducing the non-linear effects during the operation with high input laser power and maintaining the quality factor and the modulation bandwidth. For example, a micro-ring modulator with passive add-drop waveguides that modulates the optical signal by using a P/N junction within the micro-ring modulator and optimizes the coupling coefficient between the micro-ring resonant waveguide and the add-drop waveguides improves the modulation efficiency of the micro-ring modulator and reduces the signal loss during the modulation. As a result, the modulation of optical signals can be improved, thereby enabling high-speed data communication for the optical devices.

In some embodiments of the present disclosure, methods of operating the micro-ring modulators are introduced. It will be understood by those skilled in the art that the disclosure could be applied to the operation of other optical modulation devices.

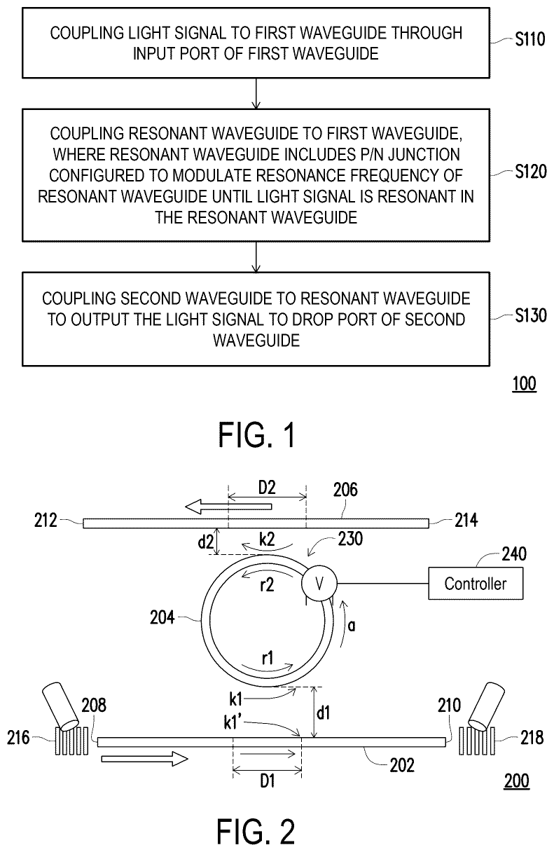

FIG. 1 illustrates a process flow 100 of operating an optical device according to embodiments of the disclosure. In some embodiments, the optical device is a micro-ring modulator.

FIG. 2 illustrates a diagram of a micro-ring modulator 200 used in the process flow in FIG. 1 according to embodiments of the present disclosure.

In some embodiments, as shown in FIG. 2, the micro-ring modulator 200 includes a first waveguide 202, a resonant waveguide 204 positioned adjacent to the first waveguide 202, and a second waveguide 206 positioned adjacent to the resonant waveguide 204.

In some embodiments, the first waveguide 202 is a bus waveguide. In some embodiments, the second waveguide 206 is an add-drop waveguide.

In some embodiments, the resonant waveguide 204 is a ring-shaped waveguide. In some examples, the resonant waveguide 204 is a circular-shaped waveguide. In some examples, the resonant waveguide 204 is an oval-shaped waveguide. In some examples, the ring-shaped waveguide has a diameter in the micrometer range.

In some embodiments, the resonant waveguide 204 can be replaced by a suitable closed-loop waveguide that is not necessarily in the above-mentioned shapes. In some embodiments, such a loop waveguide can be selected from a broad range of suitable shapes. Such suitable loop shapes typically do not have sharp corners and/or other features that can cause relatively high optical losses.

In some embodiments, the first waveguide 202 is configured to couple a light signal from an input port 208 of the first waveguide 202 to the first waveguide 202. For example, as illustrated in operation S110 of FIG. 1, the light signal is transmitted and/or coupled from a light source (not shown) by a first grating coupler 216 to the input port 208 of the first waveguide 202.

In some embodiments, the light signal is transmitted through the first waveguide 202. The light signal includes light with multiple wavelengths and the multiple wavelengths are multiplexed and transmitted through the first waveguide 202. For example, the light signal enters the input port 208 of the first waveguide 202 and is confined in the first waveguide 202 before the light signal is transmitted to a through port 210 of the first waveguide 202.

In some embodiments, as shown in FIG. 2, the light signal is further transmitted and/or coupled to a receiving device (not shown) by a second grating coupler 218 through the through port 210 of the first waveguide 202.

In some embodiments, as illustrated in operation S120 of FIG. 1, the resonant waveguide 204 is coupled to the first waveguide 202 by positioning the resonant waveguide 204 adjacent to the first waveguide 202.

In some embodiments, as shown in FIG. 2, the resonant waveguide 204 includes a P/N junction 230 that is highly doped. In some embodiments, a doping concentration is less than 1×10¹⁷ atm/cm³. In some embodiments, a doping concentration is in a range from about 1×10¹⁵ atm/cm³ to about 1×10¹⁷ atm/cm³. For example, a portion of the resonant waveguide 204 is made of N-doped silicon, a portion of the resonant waveguide 204 is made of P-doped silicon, and the two portions form the P/N junction 230. The position of the P/N junction 230 may be any place around the circumference of the resonant waveguide 204.

In some embodiments, the P/N junction 230 takes up approximately one-half of the circumference of the resonant waveguide 204. In some embodiments, the P/N junction 230 takes up more or less than one-half of the circumference of the resonant waveguide 204. In some embodiments, the P/N junction 230 is a C-shaped junction.

The P/N junction 230 may be forward-biased or reverse-biased to a bias voltage. The bias voltage may be adjusted by a controller 240 until the light signal is resonant in the resonant waveguide. The term “reverse biased” refers to an electrical configuration of a semiconductor-junction diode in which the N-type material is at a higher electrical potential, and the P-type material is at a lower electrical potential. The reverse bias typically causes the depletion layer to grow wider due to a lack of electrons and/or holes, which presents a high impedance path across the junction and substantially prevents a current flow therethrough. However, a very small reverse leakage current can still flow through the junction. Similarly, the term “forward biased” refers to an electrical configuration of a semiconductor-junction diode in which the N-type material is at a lower potential, and the P-type material is at a higher potential. If the forward bias is greater than the intrinsic voltage drop across the corresponding P/N junction, the corresponding potential barrier can be overcome by the electrical carriers, and a relatively large forward current can flow through the junction.

When the bias voltage changes, the free carrier density in the P/N junction 230 also changes, which in turn changes the effective refractive index n_{eff} of the resonant waveguide 204. Thus, by changing the bias voltage, the resonant waveguide 204 can be controlled to resonate at a resonance wavelength λ or a resonance frequency f. The resonance frequency f equals c/λ, where c is the speed of the light signal. In other words, the light signal at the wavelength λ is modulated by applying a bias voltage to the resonant waveguide 204.

n_{eff}*L=m*λ (Eq-1)

In the equation Eq-1, n_{eff} is the effective refractive index of the resonant waveguide 204, L is the circumference of the resonant waveguide 204, m is a natural number, and λ is the wavelength of the light signal that causes the resonant waveguide 204 to resonate. When the resonant waveguide 204 resonates, all or a substantial portion of the energy of the light signal at resonance wavelength λ is coupled to the resonant waveguide 204 and does not pass through the first waveguide 202.

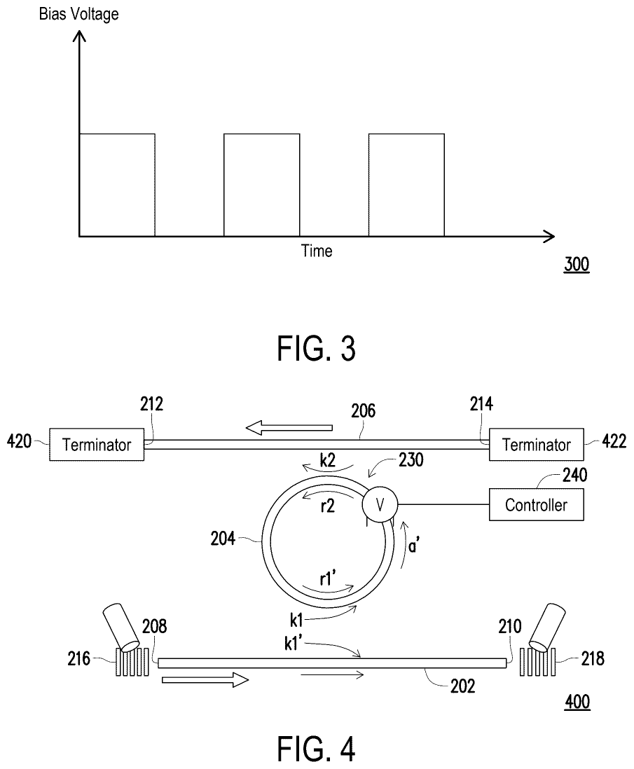

FIG. 3 illustrates a diagram of a bias voltage signal for the P/N junction 230, according to embodiments of the present disclosure. As shown in FIG. 3, the bias voltage can have a digital data pattern. In some embodiments, the bias voltage signal is a toggle electric signal between high and low.

In some embodiments, during operation S120, the bias voltage signal is applied to the P/N junction to modulate the light signal.

In some embodiments, a first coupling coefficient between the first waveguide 202 and the resonant waveguide 204 is r₁. The first coupling coefficient r₁ may be modulated by changing a first distance d₁ between the first waveguide 202 and the resonant waveguide 204. For example, the first coupling coefficient r₁ increases when the first distance between the first waveguide 202 and the resonant waveguide 204 decreases, and the first coupling coefficient r₁ decreases when the first distance between the first waveguide 202 and the resonant waveguide 204 increases.

In some embodiments, the first coupling coefficient r₁ is also modulated by changing a first coupling length D₁ between the first waveguide 202 and the resonant waveguide 204. For example, the first coupling coefficient r₁ increases when the first coupling length between the first waveguide 202 and the resonant waveguide 204 increases, and the first coupling coefficient r₁ decreases when the first coupling length between the first waveguide 202 and the resonant waveguide 204 decreases.

In some embodiments, a propagation attenuation of the resonant waveguide a is defined as the intensity attenuation coefficient of the resonant waveguide after each round trip of the light signal within the resonant waveguide 204. The intensity attenuation of the resonant waveguide may be a result of light absorption by the waveguide, leakage of the light signal from the waveguide, and scattering of the light signal by the wall roughness of the waveguide. For example, in an all-pass scenario, the round-trip attenuation is r₁*a.

In some embodiments, as illustrated in operation S130 of FIG. 1, the second waveguide 206 is coupled to the resonant waveguide 204 to couple the light signal to the second waveguide 206 by positioning the second waveguide 206 adjacent to the resonant waveguide 204. The light signal may be output through a drop port 212 of the second waveguide 206. Additionally or alternatively, the light signal may also be output through an add port 214 of the second waveguide 206. In some embodiments, the add port 214 of the second waveguide 206 does not have an output.

In some embodiments, the drop port 212 of the second waveguide 206 is connected and/or coupled to an external optical device (not shown), such that the external optical device can analyze the resonance status of the resonant waveguide 204.

In some embodiments, the propagation attenuation a of the resonant waveguide 204 is modulated to be a′, such that the below equation EQ-2 is satisfied.

a*r₁=a′*r₂ (eq-2)

In the equation Eq-2, r₂ is a second coupling coefficient between the resonant waveguide 204 and the second waveguide 206.

In some embodiments, by changing the bias voltage on the P/N junction 230, the propagation attenuation a of the resonant waveguide 204 can be modulated to be a′, such that the equation Eq-2 is satisfied.

In some embodiments, during operation S130, the bias voltage signal is applied to the P/N junction to modulate the light signal.

In some embodiments, the second coupling coefficient r₂ is also modulated by changing a second distance d₂ between the resonant waveguide 204 and the second waveguide 206. For example, the second coupling coefficient r₂ increases when the second distance between the resonant waveguide 204 and the second waveguide 206 decreases, and the second coupling coefficient r₂ decreases when the second distance between the resonant waveguide 204 and the second waveguide 206 increases.

In some embodiments, the second coupling coefficient r₂ is also modulated by changing a second coupling length D₂ between the resonant waveguide 204 and the second waveguide 206. For example, the second coupling coefficient r₂ increases when the second coupling length between the resonant waveguide 204 and the second waveguide 206 increases, and the second coupling coefficient r₂ decreases when the second coupling length between the resonant waveguide 204 and the second waveguide 206 decreases.

In some embodiments, the first coupling coefficient r₁, the second coupling coefficient r₂, and the propagation attenuation a are modulated simultaneously by changing the first distance and the first coupling length between the first waveguide 202 and the resonant waveguide 204, the second distance and the second coupling length between the resonant waveguide 204 and the second waveguide 206, and the bias voltage on the P/N junction.

When the insertion loss in the through port 210 is about −6 dB, about 75 percent of the laser power of the light signal is trapped inside the resonant waveguide 204 without the second waveguide 206 being coupled to the resonant waveguide 204. Non-linear effects, such as self-heating effects and two-photon absorption effects, may be induced in the resonant waveguide 204 as a result of the high laser power confined within the resonant waveguide 204. For example, when the laser power is greater than 0 dBm, non-linear effects will occur. In some embodiments, with the second waveguide 206 being coupled to the resonant waveguide 204, the laser power inside the resonant waveguide 204 could be reduced to about 15 percent of the laser power of the light signal by optimizing the second coupling coefficient r₂ and the propagation attenuation a.

In some embodiments, the coupling of the resonant waveguide 204 and the second waveguide 206 can result in low power consumption modulation while tuning the resonant wavelength of the micro-ring modulator.

In some embodiments, the controller 240 is configured to be electrically connected and/or coupled to the P/N junction 230 and to apply the bias voltage signal to the P/N junction 230 to modulate the light signal. In some embodiments, the controller 240 includes software and hardware for providing the bias voltage signal to the P/N junction 230.

It is understood that the controller 240 may be concentrated at a single location or distributed. In one embodiment, the controller 240 is embedded in the micro-ring modulator 200. In another embodiment, the controller 240 is remotely connected to the micro-ring modulator 200 through the Internet, intranet or other data communication mechanism. In yet another embodiment, the controller 240 is distributed among a plurality of processing apparatuses and shared by the plurality of processing apparatuses. In yet another embodiment, the controller 240 is a portion of a semiconductor device and is coupled to the processing apparatus through a suitable data communication mechanism.

FIG. 4 illustrates a diagram of an example micro-ring modulator 400 used in the process flow in FIG. 1, according to embodiments of the present disclosure. Various aspects of FIG. 4 are similar to those of FIG. 2, and such similar aspects are not further elaborated in the interest of conciseness. Various equivalent components may be used for the micro-ring modulator 400 similar to the micro-ring modulator 200 of FIG. 2.

Similar to the description of FIG. 2, as shown in FIG. 4, the micro-ring modulator 400 includes a first waveguide 202, a resonant waveguide 204 positioned adjacent to the first waveguide 202, and a second waveguide 206 positioned adjacent to the resonant waveguide 204.

In some embodiments, the micro-ring modulator 400 further includes a controller 240 configured to be electrically connected and/or coupled to the P/N junction 230 and to apply the bias voltage signal to the P/N junction 230 to modulate the light signal.

Each component of the micro-ring modulator 400 of FIG. 4 may perform similar operations as the corresponding components of the micro-ring modulator 200 of FIG. 2.

In some embodiments, the micro-ring modulator 400 further includes a first terminator 420 coupled to and/or connected with a drop port 212 of the second waveguide 206. In some embodiments, the micro-ring modulator 400 further includes a second terminator 422 coupled to and/or connected with an add port 214 of the second waveguide 206.

In some embodiments, the first terminator 420 is a doped silicon, a grating coupler, a photodiode, or the like. The first terminator 420 is configured to absorb the light signal from the second waveguide 206, such that the reflection of the light signal at the drop port 212 of the second waveguide 206 is minimized.

In some embodiments, the second terminator 422 is made of doped silicon, or is a grating coupler, a photodiode, or the like. The second terminator 422 is configured to absorb the light signal from the second waveguide 206, such that the reflection of the light signal at the add port 214 of the second waveguide 206 is minimized.

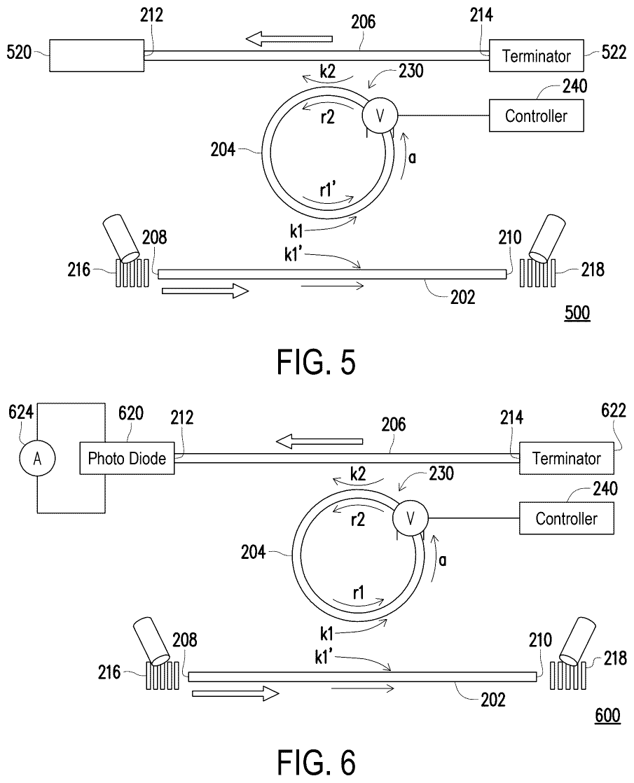

FIG. 5 illustrates a diagram of a micro-ring modulator 500 used in the process flow in FIG. 1, according to embodiments of the present disclosure. Various aspects of FIG. 5 are similar to those of FIG. 2, and such similar aspects are not further elaborated in the interest of conciseness. Various equivalent components may be used for the micro-ring modulator 500 similar to the micro-ring modulator 200 of FIG. 2.

Similar to the description above, as shown in FIG. 5, the micro-ring modulator 500 includes a first waveguide 202, a resonant waveguide 204 positioned adjacent to the first waveguide 202, and a second waveguide 206 positioned adjacent to the resonant waveguide 204.

In some embodiments, the micro-ring modulator 500 further includes a controller 240 configured to be electrically connected and/or coupled to the P/N junction 230 and to apply the bias voltage signal to the P/N junction 230 to modulate the light signal.

Each component of the micro-ring modulator 500 of FIG. 5 may perform similar operations as the corresponding components of the micro-ring modulator 200 of FIG. 2.

In some embodiments, the micro-ring modulator 500 further includes a doped terminator 520 coupled to and/or connected with a drop port 212 of the second waveguide 206.

For example, the doped terminator 520 may be an N-doped terminator or a P-doped terminator, such that the reflection of the light signal at the drop port 212 of the second waveguide 206 is minimized.

In some embodiments, the micro-ring modulator 500 further includes a terminator 522 coupled to and/or connected with an add port 214 of the second waveguide 206. For example, the terminator 522 may be made of doped silicon, or may be a grating coupler, a photodiode, or the like. The terminator 522 is configured to absorb the light signal from the second waveguide 206, such that the reflection of the light signal at the add port 214 of the second waveguide 206 is minimized.

FIG. 6 illustrates a diagram of a micro-ring modulator 600 used in the process flow in FIG. 1, according to embodiments of the present disclosure. Various aspects of FIG. 6 are similar to those of FIG. 2, and such similar aspects are not further elaborated in the interest of conciseness. Various equivalent components may be used for the micro-ring modulator 600 similar to the micro-ring modulator 200 of FIG. 2.

Similar to the description above, as shown in FIG. 6, the micro-ring modulator 600 includes a first waveguide 202, a resonant waveguide 204 positioned adjacent to the first waveguide 202, and a second waveguide 206 positioned adjacent to the resonant waveguide 204.

In some embodiments, the micro-ring modulator 600 further includes a controller 240 configured to be electrically connected and/or coupled to the P/N junction 230 and to apply the bias voltage signal to the P/N junction 230 to modulate the light signal.

Each component of the micro-ring modulator 600 of FIG. 6 may perform similar operations as the corresponding components of the micro-ring modulator 200 of FIG. 2.

In some embodiments, the micro-ring modulator 600 further includes an optical detector 620 coupled to and/or connected with a drop port 212 of the second waveguide 206.

In some embodiments, the optical detector 620 is a photodiode detector. The photodiode is optically coupled to the drop port 212 of the second waveguide 206. As a result, the photodiode may receive a small portion of the optical power of the light signal in the second waveguide 206 and convert the received light signal into a corresponding electrical output signal. In some examples, the photodiode may receive less than 10% of the optical power of the light signal in the second waveguide 206. The photodiode may receive the remaining portion of the optical power of the light signal in the second waveguide 206 and absorb the received light signal, such that the reflection of the light signal at the drop port 212 of the second waveguide 206 is minimized.

In some embodiments, the optical detector 620 is electrically connected to an electric meter 624. In some embodiments, the controller 240 is configured to be electrically connected (e.g., wired or wireless) to the electric meter 624 and configured to store and process data from the electric meter 624. In some embodiments, the controller 240 includes software and hardware to store and process data from the electric meter 624. In some embodiments, the electric meter 624 is an Ampere meter.

The electric meter 624 includes electrical circuits that operate to appropriately process, condition, and/or transform the corresponding electrical output signal from the optical detector 620 into a form that is more suitable for the signal processing implemented in the controller 240. In some embodiments, the electric meter 624 includes some or all of the following: (i) a trans-impedance amplifier; (ii) a frequency filter; (iii) a rectifier; (iv) a radio-frequency (RF) power meter or monitor; and (v) an analog-to-digital converter (ADC).

In some embodiments, the micro-ring modulator 600 further includes a terminator 622 coupled to and/or connected with an add port 214 of the second waveguide 206. For example, the terminator 622 may be made of doped silicon, or may be a grating coupler, a photodiode, or the like. The terminator 622 is configured to absorb the light signal from the second waveguide 206, such that the reflection of the light signal at the add port 214 of the second waveguide 206 is minimized.

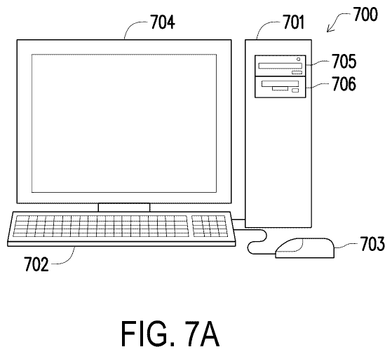

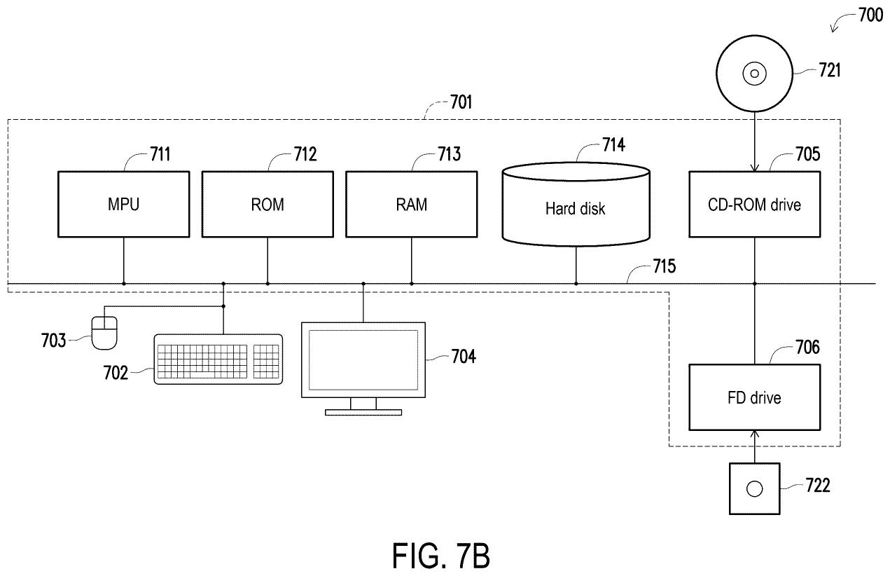

FIGS. 7A and 7B illustrate a computer system 700 for operating a micro-ring modulator (e.g., 200 of FIGS. 2, 400 of FIGS. 4, 500 of FIG. 5, and 600 of FIG. 6), according to embodiments of the disclosure. In some embodiments, the computer system 700 is used for performing the functions of the controller 240. In some embodiments, the computer system 700 is used to execute the process flow 100 of FIG. 1. All of or a part of the processes, methods and/or operations of the foregoing embodiments can be realized using computer hardware and computer programs executed thereon.

In some embodiments, the process flow 100 or a portion of the process flow 100 is performed by the controller 240. In some embodiments, the process flow 100 or a portion of the process flow 100 is performed and/or is controlled by a computer system 700 described below with respect to FIGS. 7A and 7B.

FIG. 7A is a diagram showing an external configuration of the computer system 700. In FIG. 7A, a computer system 700 is provided with a computer 701 including an optical disk read only memory (e.g., CD-ROM or DVD-ROM) drive 705 and a magnetic disk drive 706, a keyboard 702, a mouse 703, and a monitor 704.

FIG. 7B is a diagram showing an internal configuration of the computer system 700. In FIG. 7B, the computer 701 is provided with, in addition to the optical disk drive 705 and the magnetic disk drive 706, one or more processors, such as a micro processing unit (MPU) 711, a ROM 712 in which a program such as a boot up program is stored, a random access memory (RAM) 713 that is connected to the MPU 711 and in which a command of an application program is temporarily stored and a temporary storage area is provided, a hard disk 714 in which an application program, a system program, and data are stored, and a bus 715 that connects the MPU 711, the ROM 712, and the like. Note that the computer 701 may include a network card (not shown) for providing a connection to a LAN.

The program for causing the computer system 700 to execute the functions for coupling the micro-ring modulator (e.g., 200 of FIGS. 2, 400 of FIGS. 4, 500 of FIG. 5, and 600 of FIG. 6), in the foregoing embodiments may be stored in an optical disk 721 or a magnetic disk 722, which are inserted into the optical disk drive 705 or the magnetic disk drive 706, and transmitted to the hard disk 714. Alternatively, the program may be transmitted via a network (not shown) to the computer 701 and stored in the hard disk 714. At the time of execution, the program is loaded into the RAM 713. The program may be loaded from the optical disk 721 or the magnetic disk 722, or directly from a network. The program does not necessarily have to include, for example, an operating system (OS) or a third-party program to cause the computer 701 to execute the functions of the control system for coupling the micro-ring modulator (e.g., 200 of FIGS. 2, 400 of FIGS. 4, 500 of FIG. 5, and 600 of FIG. 6) in the foregoing embodiments. The program may only include a command portion to call an appropriate function (module) in a controlled mode to obtain desired results.

The novel micro-ring modulators and the operating methods according to the present disclosure provide an improved micro-ring modulator structure and methods of operating the same, thereby reducing the non-linear effects during operations with high input laser power and maintaining the quality factor and the modulation bandwidth compared to conventional techniques and configurations. Embodiments of the disclosure provide an improved micro-ring modulator with a passive add-drop waveguide that modulates the light signal by using a P/N junction within the micro-ring modulator to improve the modulation efficiency of the micro-ring modulator and reduce the signal loss during the modulation. Consequently, the modulation of optical signals can be improved, thereby enabling high-speed data communication for optical devices.

An embodiment of the disclosure is a method for operating an optical device. The optical device includes a first waveguide, a second waveguide, and a resonant waveguide. The method includes coupling a light signal into the first waveguide through an input port of the first waveguide, and coupling the resonant waveguide to the first waveguide. The resonant waveguide includes a P/N junction configured to modulate a resonance frequency of the resonant waveguide until the light signal is resonant in the resonant waveguide. The method further includes coupling the second waveguide to the resonant waveguide to output the light signal to a drop port of the second waveguide. In an embodiment, the first waveguide is a bus waveguide, the second waveguide is an add-drop waveguide, and the resonant waveguide is a ring-shaped resonant waveguide. In an embodiment, coupling the resonant waveguide to the first waveguide includes: applying a bias voltage to the P/N junction to modulate an index of the resonant waveguide until the light signal is resonant in the resonant waveguide. In an embodiment, a first coupling coefficient between the first waveguide and the resonant waveguide is r₁, a propagation attenuation of the resonant waveguide is a, and a second coupling coefficient between the resonant waveguide and the second waveguide is r₂, wherein the propagation attenuation of the resonant waveguide is modulated to be a′, and a*r₁=a′*r₂. In an embodiment, the propagation attenuation of the resonant waveguide is modulated by the P/N junction. In an embodiment, the first coupling coefficient. In an embodiment, the optical device further includes a first terminator coupled to the drop port of the second waveguide, and a second terminator coupled to an add port of the second waveguide, where the first terminator and the second terminator are configured to absorb the light signal from the second waveguide. In an embodiment, the first terminator is made of doped silicon, or is a grating coupler, or a photodiode, and the second terminator is made of doped silicon, or is a grating coupler, or a photodiode. In an embodiment, the first terminator is a photodiode, wherein the photodiode is configured to monitor the light signal in the second waveguide.

Another embodiment of the disclosure is an optical device, including a first waveguide configured to couple a light signal to the first waveguide through an input port of the first waveguide, and a resonant waveguide coupled to the first waveguide. The resonant waveguide includes a P/N junction configured to modulate a resonant frequency of the resonant waveguide until the light signal is resonant in the resonant waveguide. The optical device further includes a second waveguide coupled to the resonant waveguide to output the light signal to a drop port of the second waveguide. In an embodiment, the first waveguide is a bus waveguide, the second waveguide is an add-drop waveguide, and the resonant waveguide is a ring-shaped resonant waveguide. In an embodiment, the P/N junction is electrically coupled to a controller, and the controller is configured to apply a bias voltage to the P/N junction to modulate an index of the resonant waveguide until the light signal is resonant in the resonant waveguide. In an embodiment, a first coupling coefficient between the first waveguide and the resonant waveguide is r₁, a propagation attenuation of the resonant waveguide is a, and a second coupling coefficient between the resonant waveguide and the second waveguide is r₂, where the propagation attenuation of the resonant waveguide is modulated to be a′, and a*r₁=a′*r₂. In an embodiment, the propagation attenuation of the resonant waveguide is modulated by the P/N junction. In an embodiment, the first coupling coefficient and the second coupling coefficient are further modulated to maintain a*r₁=a′*r₂. In an embodiment, a first terminator is coupled to the drop port of the second waveguide, and a second terminator is coupled to an add port of the second waveguide, where the first terminator and the second terminator are configured to absorb the light signal from the second waveguide. In an embodiment, the first terminator is made of doped silicon, or is a grating coupler, or a photodiode, and the second terminator is made of doped silicon, or is a grating coupler, or a photodiode.

Another embodiment of the disclosure is a method for operating an optical device, where the optical device includes a first waveguide, a second waveguide, and a resonant waveguide. The method includes coupling a light signal to the first waveguide through an input port of the first waveguide, and coupling the resonant waveguide to the first waveguide. The resonant waveguide includes a P/N junction configured to modulate a resonance frequency of the resonant waveguide until the light signal is resonant in the resonant waveguide, and a first coupling coefficient between the first waveguide and the resonant waveguide is r₁, and a propagation attenuation of the resonant waveguide is a. The method further includes coupling the second waveguide to the resonant waveguide to output the light signal to a drop port of the second waveguide, where a second coupling coefficient between the resonant waveguide and the second waveguide is r₂, the propagation attenuation of the resonant waveguide is modulated to be a′, and a*r₁=a′*r₂. In an embodiment, the first waveguide is a bus waveguide, the second waveguide is an add-drop waveguide, and the resonant waveguide is a ring-shaped resonant waveguide. In an embodiment, coupling the resonant waveguide to the first waveguide includes applying a bias voltage to the P/N junction to modulate an index of the resonant waveguide until the light signal is resonant in the resonant waveguide.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for operating an optical device, wherein the optical device includes a first waveguide, a second waveguide, and a closed-loop waveguide, the method comprising:
transmitting a light signal from an input port of the first waveguide to a through port of the first waveguide;
coupling the closed-loop waveguide to the first waveguide, wherein the closed-loop waveguide includes a P/N junction;
applying an electrical signal to the P/N junction to modulate a resonant frequency of the closed-loop waveguide until the light signal is resonant in the closed-loop waveguide; and
coupling the second waveguide to the closed-loop waveguide to absorb the light signal at a drop port of the second waveguide.

2. The method according to claim 1, wherein:
the first waveguide is a bus waveguide,
the second waveguide is an add-drop waveguide, and
the closed-loop waveguide is a ring-shaped resonant waveguide.

3. The method according to claim 1, wherein the electrical signal is a bias voltage that modulates an index of the closed-loop waveguide until the light signal is resonant in the closed-loop waveguide.

4. The method according to claim 1, wherein:
a first coupling coefficient between the first waveguide and the closed-loop waveguide is r₁,
a propagation attenuation of the closed-loop waveguide is a, and
a second coupling coefficient between the closed-loop waveguide and the second waveguide is r₂, wherein the propagation attenuation of the closed-loop waveguide is modulated to be a′, and a*r₁=a′*r₂.

5. The method according to claim 4, wherein:
the propagation attenuation of the closed-loop waveguide is modulated by the P/N junction.

6. The method according to claim 4, wherein:
the first coupling coefficient and the second coupling coefficient are further modulated to maintain a*r₁=a′*r₂.

7. The method according to claim 1, wherein the optical device further includes:
a first terminator coupled to the drop port of the second waveguide; and
a second terminator coupled to an add port of the second waveguide, wherein the first terminator and the second terminator are configured to absorb the light signal from the second waveguide.

8. The method according to claim 7, wherein:
the first terminator is made of doped silicon, or is a grating coupler, or a photodiode, and
the second terminator is made of doped silicon, or is a grating coupler, or a photodiode.

9. The method according to claim 7, wherein the first terminator is a photodiode, wherein the photodiode is configured to monitor the light signal in the second waveguide.

10. An optical device comprising:
a first waveguide configured to transmit a light signal from an input port of the first waveguide to a through port of the first waveguide;
a closed-loop waveguide coupled to the first waveguide, wherein the closed-loop waveguide includes a P/N junction;
a controller configured to apply an electrical signal to the P/N junction to modulate a resonant frequency of the closed-loop waveguide until the light signal is resonant in the closed-loop waveguide; and
a second waveguide coupled to the closed-loop waveguide configured to absorb the light signal at a drop port of the second waveguide.

11. The optical device according to claim 10, wherein:
the first waveguide is a bus waveguide,
the second waveguide is an add-drop waveguide, and
the closed-loop waveguide is a ring-shaped resonant waveguide.

12. The optical device according to claim 10, wherein the electrical signal is a bias voltage that modulates an index of the closed-loop waveguide until the light signal is resonant in the closed-loop waveguide.

13. The optical device according to claim 10, wherein:
a first coupling coefficient between the first waveguide and the closed-loop waveguide is r₁,
a propagation attenuation of the closed-loop waveguide is a, and
a second coupling coefficient between the closed-loop waveguide and the second waveguide is r₂, wherein the propagation attenuation of the closed-loop waveguide is modulated to be a′, and a*r₁=a′*r₂.

14. The optical device according to claim 13, wherein the propagation attenuation of the closed-loop waveguide is modulated by the P/N junction.

15. The optical device according to claim 13, wherein:
the first coupling coefficient and the second coupling coefficient are further modulated to maintain a*r₁=a′*r₂.

16. The optical device according to claim 10, further comprising:
a first terminator coupled to the drop port of the second waveguide; and
a second terminator coupled to an add port of the second waveguide, wherein the first terminator and the second terminator are configured to absorb the light signal from the second waveguide.

17. The optical device according to claim 16, wherein:
the first terminator comprises doped silicon, or is a grating coupler, or a photodiode, and
the second terminator comprises doped silicon, or is a grating coupler, or a photodiode.

18. A method for operating an optical device, wherein the optical device includes a first waveguide, a second waveguide, and a closed-loop waveguide, the method comprising:
transmitting a light signal from an input port of the first waveguide to a through port of the first waveguide;
coupling the closed-loop waveguide to the first waveguide, wherein the closed-loop waveguide includes a C-shaped P/N junction configured to modulate an index of the closed-loop waveguide until the light signal is resonant in the closed-loop waveguide;
coupling the second waveguide to the closed-loop waveguide; and
monitoring, by an optical detector, the light signal at a drop port of the second waveguide.

19. The method according to claim 18, wherein:
the first waveguide is a bus waveguide,
the second waveguide is an add-drop waveguide, and
the closed-loop waveguide is a ring-shaped resonant waveguide.

20. The method according to claim 18, wherein a terminator is coupled to an add port of the second waveguide, wherein the terminator is configured to absorb the light signal from the second waveguide.
